(19) United States
(12) Patent Application Publication
(10) Pub. No.: US 2005/0046698 A1
(43) Pub. Date: Mar. 3, 2005

(54) System and method for producing a selectable view of an object space

(76) Inventor: Andrew Frederick Knight, Arlington, VA (US)

Correspondence Address: ANDREW F. KNIGHT, 2225 LOVEDALE LN, APT F, RESTON, VA, 20191, US

(21) Appl. No.: 10/651,950

(22) Filed: Sep. 2, 2003

(51) Int. Cl. H04N 7/18

(52) U.S. Cl. 348/157

(57) ABSTRACT

A system and method for producing a selectable view of an object space include: a) dividing the object space into n object sections to be imaged; b) providing at least n cameras, where the cameras are configured such that each object section is associated with at least one unique camera configured to image substantially only that object section; and c) imaging each of the object sections with its unique camera, so as to create at least one image of each object section, where the images of the object sections are combined to create a substantially continuous composite mosaic of the object space, where a view of a portion of the mosaic is selectably provided to a user based on selection instructions from the user, and where at least one of the view, the mosaic, and the images of the object sections is sent to the user via an information network, such as a cable network. The view may be provided in 3D to the user via a head-mounted display, and the selection instructions may include a physical orientation of the display.

### BACKGROUND OF THE INVENTION

Currently, when people watch a show on television for which there is a very large object space, such as a sports game (football, baseball, basketball, etc.), a concert, a talk show, or the like, the available view is limited by the view or views chosen by the videographers of the show. For example, in a televised baseball game, the total area of possibly interesting views is very large. This area includes not only the entire baseball diamond and outfield, but may also include the stands or bleachers in which screaming fans attempt to catch a foul ball or homerun hit. Unfortunately, when the videographer zooms out to show the entire interesting object space, the resolution becomes very poor, and the features and activities of individual people or players becomes very difficult, if not impossible, to distinguish. The videographer solves this problem by zooming in on the most interesting person or player, such as the player at bat, with the consequence that the television viewing public cannot view anything else. Not only does a person watching television have no option about which section of the object space to view, and with what resolution (i.e., how much zoomed in or out), but additionally the view on television is not very natural. In other words, a fan in the bleachers may naturally choose his own view by moving his head in different directions. In contrast, the view available to the television watching person is not affected by her bodily motions, or the turning of her head. The result is a very artificial viewing experience which is very detached from the experience of a fan in the bleachers.

### SUMMARY OF THE INVENTION

The present invention aims to solve these and other problems.

In a preferred embodiment according to the present invention, a method for producing a selectable view of an object space may comprise: a) dividing the object space into a plurality n of object sections to be imaged; b) providing at least n cameras, wherein the cameras are configured such that each object section is associated with at least one unique camera configured to image substantially only that object section; and c) imaging each of the object sections with the unique camera unique to that object section, so as to create at least one image of each object section, wherein the images of the object sections are combined to create a substantially continuous composite mosaic of the object space, wherein a view of a portion of the mosaic is selectably provided to a user based on selection instructions from the user, and wherein at least one of the view, the mosaic, and the images of the object sections is sent to the user via an information network, such as a cable television network. The view may be provided to the viewer via a head-mounted display. Further, the view may be selectable by the user based at least in part on a physical orientation of the head-mounted display.

In a preferred aspect of the present invention, at least two of the object sections may be imaged at different focal distances. Further, each of the images of the object sections may be sent to the user on a different cable channel.

In another preferred aspect of the present invention, n may be at least 9. Further, step c) may comprise imaging each of the object sections with a refresh rate of at least 15 times per second, wherein the view is selectably provided to the user with a refresh rate of at least 15 times per second. Further, the object space may comprise a field for a sporting event.

In another preferred aspect of the present invention, step b) may comprise providing 2n cameras, wherein the cameras are configured such that each object section is associated with two unique cameras, spaced an approximate distance d apart, configured to image substantially only that object section, and step c) may comprise imaging each of the object sections with the two unique cameras, so as to create first and second images of each object section, and the first images of the object sections may be combined to create a first composite mosaic of the object space, and the second images of the object sections may be combined to create a second composite mosaic of the object space, and the first and second images of the object sections or the first and second mosaics may be sent to the user via the information network, and a view of a portion of the first mosaic and a corresponding view of a corresponding portion of the second mosaic may be selectably provided to the user based on selection instructions from the user, so as to provide to the user a three-dimensional representational view of a portion of the object space. The distance d may be equal to or substantially greater than an approximate distance between human eyes.

In another preferred embodiment of the present invention, a system for providing a selectable view of an object space may comprise: a plurality of cameras configured to image a plurality of object sections of the object space, wherein each object section is associated with at least one unique camera configured to image substantially only that object section; a first image processor connected to the plurality of cameras and configured to combine the images of the object sections into a substantially continuous composite mosaic of the object space; a second image processor connected to the first image processor and configured to extract a selected view of a portion of the mosaic from the mosaic based on selection instructions from a user; a display connected to the second image processor and configured to display the selected view to the user; and an interface connected to the second image processor and configured to provide the selection instructions to the second image processor. The display may be a wireless head-mounted display and the interface may comprise an orientation detector configured to detect a physical orientation of the head-mounted display, wherein the selection instructions are based at least in part on the physical orientation.

In a preferred aspect of the present invention, the selection instructions may comprise at least two components: a) a position component corresponding to a position of the selected view with respect to the mosaic; and b) a size component corresponding to a size of the selected view with respect to the mosaic, wherein the user may zoom-in in the mosaic by decreasing the size of the selected view and may zoom-out in the mosaic by increasing the size of the selected view.

In another preferred aspect of the present invention, each object section may be associated with two unique cameras, spaced an approximate distance d apart, configured to image substantially only that object section, so as to create first and second images of that object section, and the first image processor may be configured to combine the first images of the object sections into a first composite mosaic of the object space, and to combine the second images of the object sections into a second composite mosaic of the object space, and the second image processor may be configured to extract a selected view of a portion of the first mosaic and a corresponding view of a corresponding portion of the second mosaic based on selection instructions from the user, and the display may comprise a first-eye display and a second-eye display and may be configured to display the selected view to the user via the first-eye display and to display the corresponding view to the user via the second-eye display. The selection instructions may comprise a 3D/2D component corresponding to a selection between a three-dimensional and a two-dimensional view, respectively.

In another preferred aspect of the present invention, each object section may be associated with at least two unique cameras configured to image substantially only that object section, wherein the at least two unique cameras have different focal distances, and the selection instructions may comprise a focus component corresponding to a selection between images created by the at least two unique cameras.

### BRIEF DESCRIPTION OF THE DRAWINGS

FIG. 1 shows a schematic view of a system according to the present invention.

FIG. 2 illustrates three different mosaic cameras according to preferred embodiments of the present invention.

FIG. 3 illustrates a an example of a use and operation of the mosaic camera with respect to a field of interest.

FIG. 4 illustrates the creation of a mosaic from individual images.

FIG. 5 illustrates the selection and presentation of a view of a portion of a mosaic to a user via either a TV/display or a head-mounted display.

FIG. 6 illustrates a three-dimensional embodiment of the present invention.

### DETAILED DESCRIPTION OF PREFERRED EMBODIMENTS

The following description will refer to digital images, digital video, digital pixels, digital image processing, and the like. However, one skilled in the art will recognize that the invention is not limited to digital embodiments.

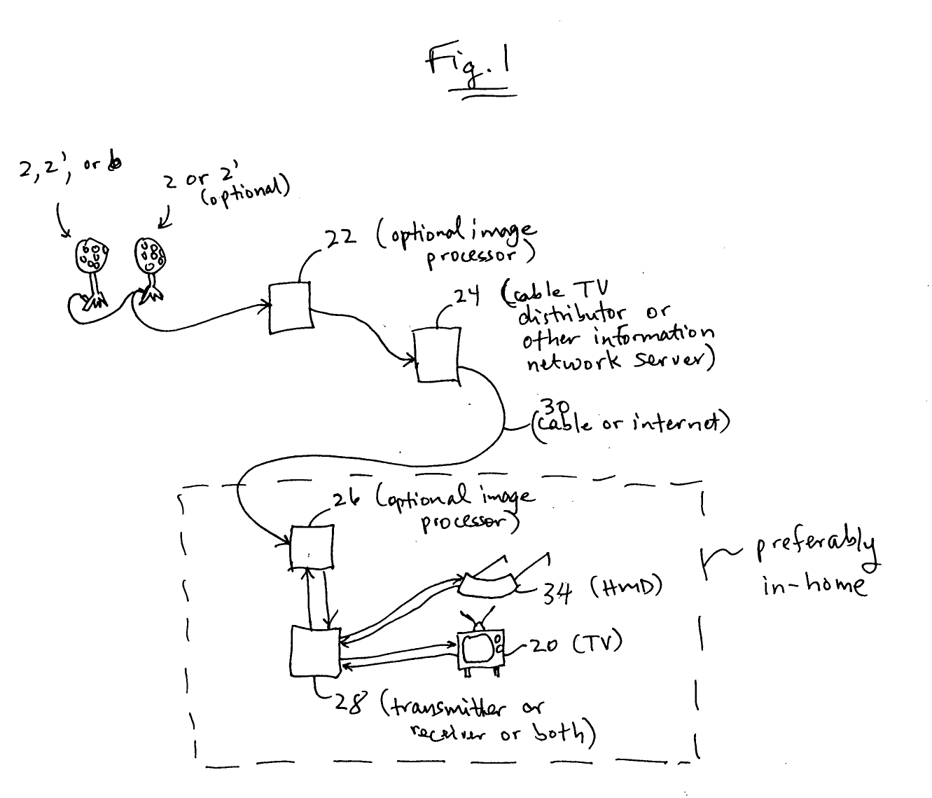

Referring to FIG. 1, a system according to the present invention may include at least one mosaic camera 2, 2′, 6, a first image processor 22, an image distributor 24 (such as a cable TV distributor, an information network server, an internet server, or the like), an information line 30 (such as cable or internet), a second image processor 26, a transceiver or interface 28, and either a head-mounted display 34, a TV or display monitor 20, or both. Preferably, the second image processor 26, transceiver 28, and display 20, 34 are located inside the residence of a user of the invention, such as in her living room.

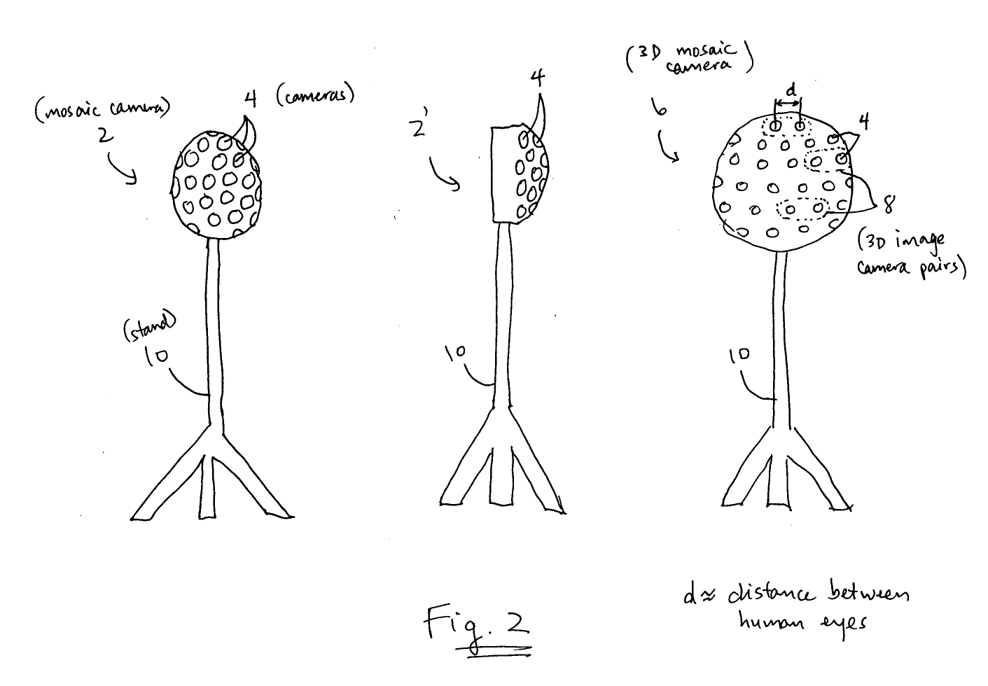

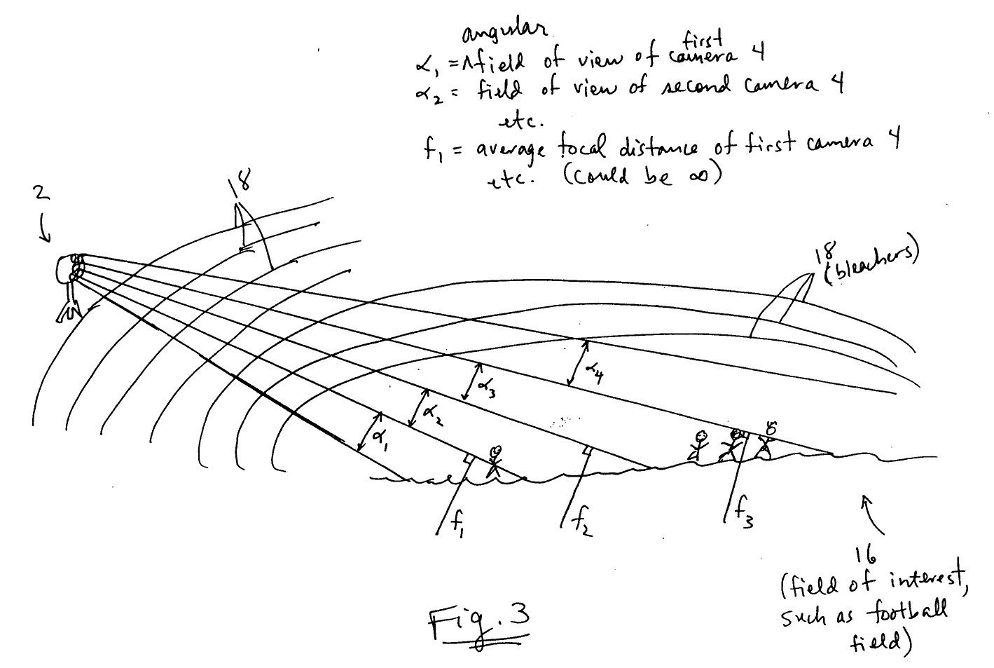

The mosaic cameras 2, 2′, 6 are illustrated further in FIG. 2. Mosaic camera 2 contains a plurality of cameras 4 (preferably video cameras) attached to a preferably round or spherical surface, as shown, and is supported on a stand 10. The lens of each camera 2 may be configured so that an optical axis of the lens may be perpendicular to a plane tangent to a surface of the sphere. In this manner, the cameras 4 are each aimed in a substantially different direction. The cameras 4 may further be configured and spaced apart from each other so that, when the cameras 4 are all focused at objects at infinity, the object space imaged imaged by adjacent cameras is fully imaged, without any gaps. For example, referring to FIG. 3 (which will be discussed in greater detail later), mosaic camera 2 includes at least first through fourth cameras 4, configured and aimed so that the entire object space of the field of interest 16 is imaged by the four cameras 4 without any gaps. In other words, the edges of the imaging capability of the second camera (imaging an angle denoted by α₂) are met by the edges of the imaging capability of the first and third cameras (imaging angles denoted by α₁ and α₃, respectively). Thus, an entire object space may be imaged even where no single camera can image the object space with the required or desired resolution. In reality, as discussed later, there is preferably some overlap in the images obtained by adjacent cameras 4 in the mosaic camera 2, to allow for: a) manufacturing imperfections; b) changes in the field of view available to each camera 4 when each camera 4 is focused to a distance other than infinity, c) misalignment of the cameras 4, etc.

Back to FIG. 2, another mosaic camera 2′ is shown, containing cameras 4 on only a portion of a sphere. Where mosaic camera 2 is capable of imaging an object space with a solid angle of almost 4π (i.e., the mosaic camera 2 can image in virtually every direction), mosaic camera 2′ is capable of imaging a much smaller solid angle, particularly that solid angle corresponding to the most interesting object space. For example, mosaic camera 2′ may be used in FIG. 3, because the field of interest 16 may comprise a solid angle with respect to the mosaic camera 2′ having an angular width of only α₁+α₂+α₃+α₄. As is known by one skilled in the art, FIG. 3, a 2D drawing, depicts only a 1D width of the solid angle imaged by the mosaic camera 2′, where solid angle is a 2D unit. The benefit to mosaic camera 2′ is, of course, that it may be designed and placed so that only the most interesting solid angle (i.e., that solid angle encompassing the most interesting field of interest 16 of an object space) is imaged.

FIG. 2 also depicts a 3D mosaic camera 6, comprising a series of 3D image camera pairs 8, each pair consisting of two (or more, depending on the application) cameras 4, preferably spaced apart by a distance d, the distance d corresponding to an approximate or average distance between human eyes. Each of the two cameras in each 3D image camera pair 8 is preferably aimed at the same general object space, so that they image substantially the same solid angle. As is known in the art, where the location of the imaged object space is much farther than the focal distance of the lenses of the cameras 4, this may be effectively accomplished by configuring the cameras 4 in each 3D image camera pair 8 so that their optical axes are parallel or very close to parallel. Other than that feature, the 3D mosaic camera 6 may be similar to the mosaic camera 2 or 2′. For example, the 3D image camera pairs 8 may be spaced out and configured to image an entire desired object space without gaps. Preferably, an axis running through the centers of the lenses of the cameras 4 in each 3D image camera pair 8 is horizontal, so that each camera pair 8 substantially mimics the eyes of an upright human person.

Referring now to FIG. 3, a field of interest 16 is shown, such as a football or baseball field. The field may be located inside a stadium having bleachers or stands 18 for spectators. The mosaic camera 2 (or 2′ or 6) may be located anywhere with respect to the field of interest 16, as long as the solid angle imagable by the mosaic camera 2 includes the entire field of interest 16. Preferably, the mosaic camera 2 is located in the bleachers 18, so that the images created by the mosaic camera 2 mimic those images as seen by an actual spectator sitting in the bleachers 18. Also, in a preferred embodiment, the mosaic camera is located relatively far from the field of interest 16, so that any differences in focus among different cameras 4 in the mosaic camera 2 are relatively small. For example, consider a first mosaic camera 2 located 10 yards from one edge of a 100-yard football field (not shown), and a second mosaic camera 2 located 100 yards from the edge of the field. If one camera 4 in the second mosaic camera 2 (such as the first camera 4 having angular field of view α₁) has an average focal distance f₁ (which may be 100+20=120 yards) and another camera (such as the second camera 4 having angular field of view α₂) has an average focal distance f₂ (which may be 100+50=150 yards), the difference in focus between the first and second cameras 4 is related the ratio of these focal distances, or 150/120=1.25. However, if one camera 4 in the first mosaic has an average focal distance of 10+20=30 yards and another camera has an average focal distance of 10+50=60 yards, then the ratio of these focal distances is 60/30=2.0. In order to put together the images created by the individual cameras 4 in the mosaic camera 2 (as will be discussed later), the variation in the focal distances among adjacent cameras 4 should be minimized. Further, if mosaic camera 2 is sufficiently far from the field of interest 16, some or all of its cameras 4 may be set to a focal distance of infinity.

The focal distance of each camera 4 may be fixed or variable. For example, each camera 4 may have a fixed focal distance of infinity, or it may have a focal distance fixed at an average distance of the object section imaged by the camera 4. Alternatively, each camera 4 may be configured to manually (e.g., by a trained videographer) or automatically focus on the thing or things that are most interesting in the object section of the image space imaged by the camera 4. For example, if a player is running with the football from one edge of the object section to another edge, the camera 4 may automatically focus on the player as he moves through the object section. Because solid angle imaged by a camera 4 may change with changes in the camera's focal distance, the cameras 4 in the mosaic camera 2 may be configured and aimed so that the solid angles imaged by adjacent cameras 4 overlap some. Thus, independently of what focal distance in a range of available focal distances each camera 4 is set at, the entire object space continues to be imaged without gaps or breaks between adjacent images. The amount of desired overlap will depend on the range of available focal distances of each camera 4 (i.e., the possible range of distances of interesting things within the object section imaged by each camera 4), the manufacturing tolerances of the mosaic camera 2, etc.

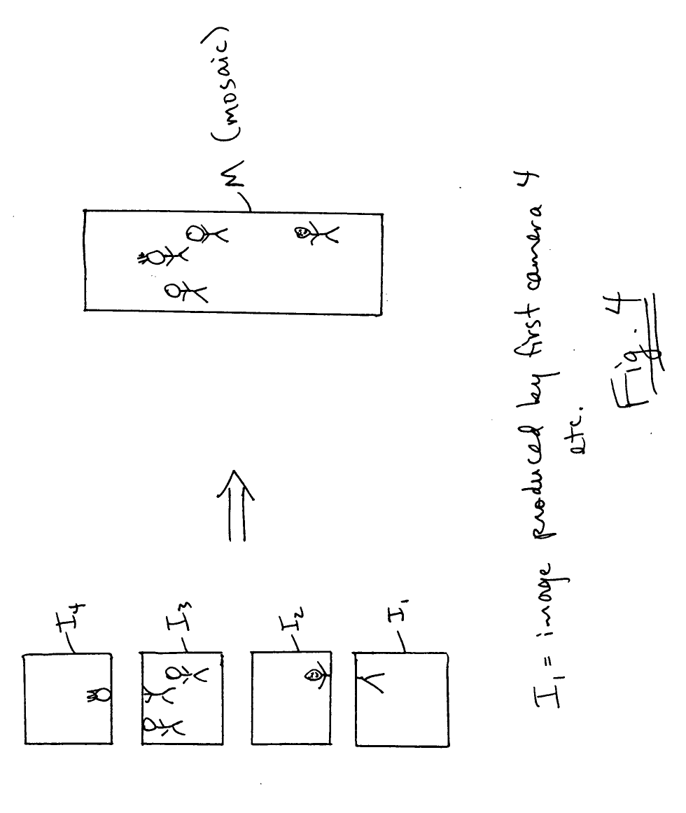

Referring now to FIGS. 1 and 4, the first image processor 22 may be configured to process the images created from the individual cameras 4 in the mosaic camera 2. For example, the four images 11, 12, 13, 14 created by the first through fourth cameras 4, respectively, shown in FIG. 3 are shown in FIG. 4. The first image processor 22 puts these images together and creates mosaic M. Ways of performing this task are known in the art. One simple way is simply to place all adjacent images edge-to-edge. Where the focal distances of each of the cameras 4 are fixed (e.g., they are individually fixed, or they are all fixed at a particular distance, such as infinity), and where the cameras 4 are very well aligned in the mosaic camera 2 with very tight manufacturing tolerances, the images created by the cameras 4 may simply be stacked edge-to-edge, with a resulting composite mosaic that is a relatively good optical representation of the entire object space. Much better means for combining the images into a mosaic may be available. For example, one method is by pixel matching, or, better yet, best-fit or root-mean-square minimization (RMS) pixel matching. In the pixel matching method, two images that image adjacent object sections with some overlap may be put together in a continuous mosaic by recognizing that, in the overlap regions of each image, the images will contain similar or identical information (i.e., matching pixel rows, columns, or regions). The first image processor 22 searches for these rows, columns, or regions of identically (or substantially identically) matching pixel information, and meshes the two images so that their matching pixel information is aligned. Thus, a single continuous composite mosaic of the two images can be created, so that a single mosaic of the object space imaged in two object sections by the two adjacent cameras 4 can be created. A best-fit or RMS pixel matching method is similar to the pixel matching method, but simply adds the recognition that the overlap regions of images imaging adjacent object sections may not contain identical pixel information. For example, due to slight differences due to manufacturing, one camera may assign a color code of 96 to one pixel, and another camera may assign a color code of 94 or 95 to a corresponding pixel (i.e., a pixel corresponding to the same imaged point in the object space). Another example is that the first camera 4 may be set at a different focal distance than the second camera 4, so that the colors of corresponding pixels in the overlap regions of the images created by these cameras 4 may be slightly different. There are lots of other reasons, as would be known to one skilled in the art, why the overlapping regions of images of adjacent object sections may contain different pixel information. However, a smart image processor 22 is capable of looking at the overlapping regions of two adjacent images (i.e., images of adjacent object sections) as a whole and, using a best-fit or RMS model, can determine where the overlap regions start and end. (Presumably, the cameras 4 are configured so that all adjacent images having overlap regions. The first image processor 22 therefore has the job of determining where these regions start and end on adjacent images, so that the images can be meshed properly such that the overlap regions are melded into one.) For example, two adjacent images may be meshed on top of each other, and the RMS of the differences in overlapping pixel color may be determined. The adjacent images can then be meshed in a different way, and the RMS determined. This process may be continued until the RMS is minimized, and the adjacent images are permanently meshed in this configuration. Methods for improving the speed of performing such RMS methods are known. Further, the individual images created by the cameras 4 may need to be enlarged or reduced before, during, or after the meshing process of the first image processor 22.

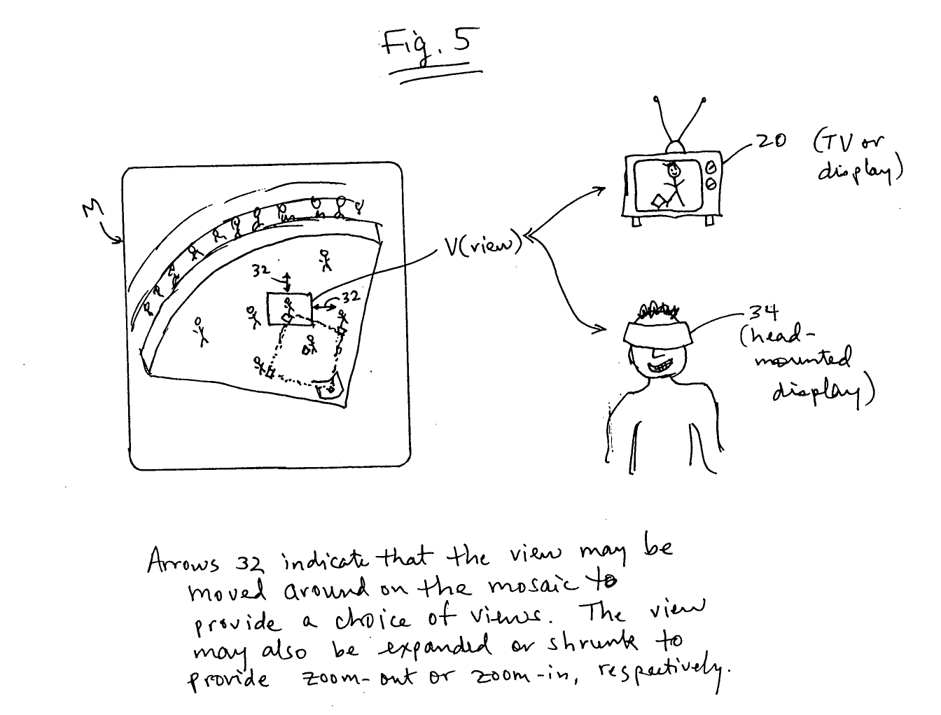

Referring now to FIGS. 1 and 5, the substantially continuous composite mosaic M produced by the first image processor 22 is then sent to the image distributor 24, which is preferably cable television or an information network server (such as an internet server).

Next, the composite mosaic M is routed to a second image processor 26 via cable or internet lines 30. The second image processor 26, which is preferably located in the home of the user, is responsible for extracting a selected view from the composite mosaic M according to instructions input into the second image processor 26 by the user. For example, as shown in FIG. 5, assume that, at a given instant, the composite mosaic M is as shown. The user selects view V as shown, where view V is a portion of the mosaic M. The second image processor 26 then extracts this view V from the mosaic M and formats (e.g., enlarges or shrinks) the view V for display by a head-mounted display 34 or TV (or other display, such as a monitor) 20. As shown in FIG. 1, the system preferably comprises an interface 28, which may serve as a transmitter, receiver, or both, which is configured to send the view V extracted from the mosaic M to the display 20, 34 for viewing by the user. The interface 28 may also or alternatively be configured to receive selection instructions from the user and input these instructions into the second image processor 26. There may be a wireless connection between the interface 28 and the display 20, 34.

The user may input selection instructions into the interface 28 in a number of ways. For example, the interface 28 may comprise a remote control, such as a joystick, in which movement of the joystick upwards provides selection instructions to the second image processor 26 to move the view V upward in the mosaic M (see, e.g., arrows 32 in FIG. 5), commensurate with a magnitude of the joystick movement. Further, the interface 28 may comprise an infrared pointer and a receiver, configured so that when the user points the pointer downward, the interface 28 provides selection instructions to the second image processor 26 to move the view V downward in the mosaic M. Such input devices are readily known in the art. The interface 28 may also include an input device configured to adjust a size of the view V. For example, when the user chooses a larger view V, then after the second image processor 26 extracts the view V from the mosaic M and formats the size for display on the display 20, 34, it appears to the user that the view V has been “zoomed out,” as is well known in the art. Thus, to provide zoom control to the user, the interface 28 may comprise an input device to provide selection instructions to the second image processor 26 to increase or decrease the size of the view V with respect to the mosaic M. Many other possible adjustments to the view V may be included in the selection instructions from the user and provided to the second image processor 26. Only a few have been mentioned for the sake of simplicity, but any such instructions known in the art are within the scope of the present invention.

Further, in the case where the display is the head-mounted display (HMD) 34, the interface 28 may comprise an orientation detector configured to detect an orientation of the head-mounted display 34. There are many such means known in the art to determine the physical orientation of a body in space, and will not be discussed in depth here. By way of example but not limitation, a gyroscopic system may be mounted in the HMD 34, providing information to the receiver/interface 28 regarding its physical orientation. The interface 28 may be configured so that as the user (who is wearing HMD 34) looks to the right, movement of the HMD 34 to the right provides selection instructions to the second image processor 26 to move the view V to the right in the mosaic M, commensurate with a magnitude of the motion.

The first image processor 22 and the second image processor 26 may be combined into one unit, and/or both image processors 22, 26 may be located on the same side of the image distributor 24 (preferably the in-home side). For example, the images created by the mosaic camera(s) 2, 2′, 6 may be sent, without substantial processing, over the cable or internet line 30 via the image distributor 24, to the image processor 26. For example, each image created by the mosaic camera 2, 2′, 6 (i.e., the image of each individual object section of the whole object space) may be sent on a different cable channel through the cable line 30. The image processor 26 may then be configured to put the individual images together to create the composite mosaic of the object space, and to provide the user with a view of a portion of the mosaic. Instead, in order to reduce the necessary bandwidth of the cable or information line 30, the first and second image processors 22, 26 may be located on the other size of the cable or information line 30. In such an embodiment, the processing of these large images and mosaics can be performed without the need of sending all images or the whole mosaic to the user's home via the cable or information line 30. In such an example, the selection instructions are sent to the second image processor 26 via the cable or information line 30 (preferably at a fast rate, such as the same refresh rate of the images and mosaic, which may be 15 or 30 times per second). Then, the second image processor 26 sends the appropriate extracted view V to the user via interface 28 and cable or information line 30.

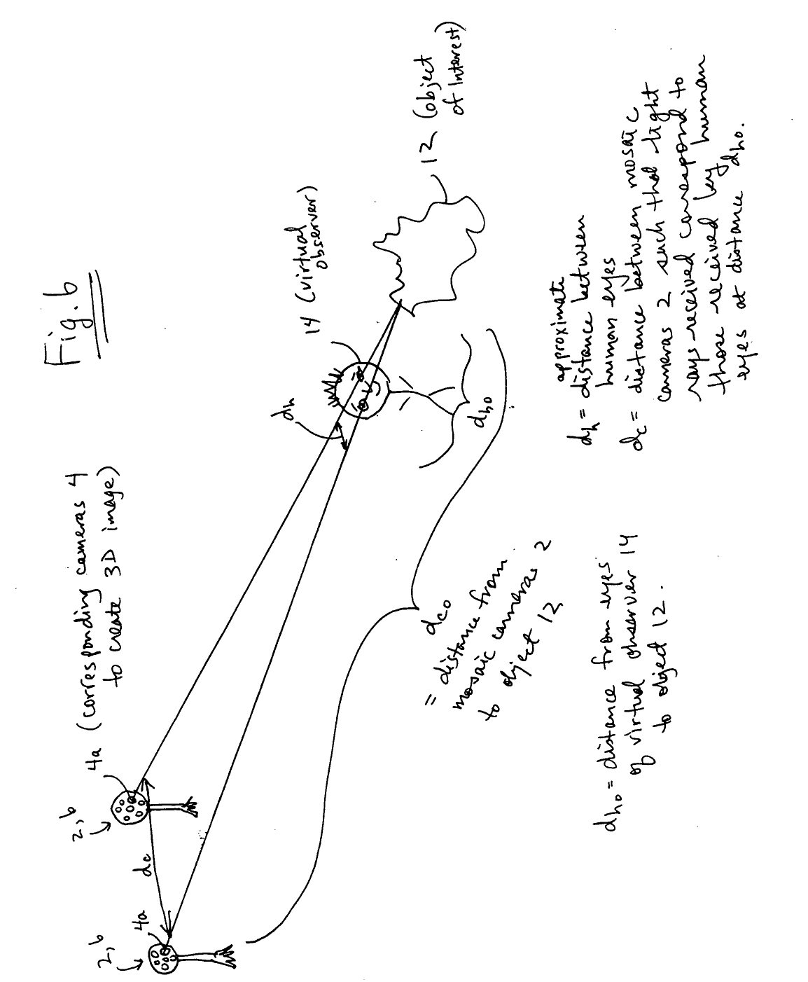

Referring now to FIGS. 2 and 6, a three-dimensional version of the present invention is shown. For each object section imaged by a system according to the present invention, there is provided preferably two (or more) cameras 4, each configured to image substantially the same object section. Each camera 4a has a corresponding camera 4a, and the pair of such cameras 4a, 4a is a 3D image camera pair 8, as shown in FIG. 2. (However, as shown in FIG. 6, such pairs need not be located on the same mosaic camera 2, 2′, 6.) The operation of the mosaic cameras 2 shown in FIG. 6 is similar to that described previously. However, instead of creating one composite mosaic, two composite mosaics of substantially the same object space are created by the first image processor 22 and sent by the image distributor 24 to the second image processor 26 via cable or information line 30. When the user provides selection instructions to the second image processor 26, the second image processor 26 extracts a selected view from the first mosaic and a corresponding view from the second mosaic (e.g., in the same relative location as in the first mosaic), and then sends the two views to the 3D display (such as HMD 34) such that one side (e.g., a left side) of the HMD 34 displays the selected view and the other side displays the corresponding view. The system thus provides the user with a 3D perspective representation of the selected portion of the object space.

In the case of the mosaic camera 6 shown in FIG. 2, the distance d between cameras 4 in each 3D image camera pair 8 is preferably an approximate or average distance between human eyes, and, preferably, the optical axes of the cameras 4 in each camera pair 8 are approximately parallel. Thus, a 3D image may be provided to the user largely independently of a distance of the 3D mosaic camera 6 to the viewed object space. (All that is necessary is that each camera 4 in each camera pair 8 is properly focused on the object space.) This is because the distance between the optical axes of cameras 4 in each camera pair 8 remains approximately constant at d. In other words, each camera pair 8 is effectively acting as a set of human eyes, so that the perspective perceived by the user when viewing view V on the HMD 34 is approximately the same perspective as if the user were viewing the object space (corresponding to view V) from the physical position of the 3D mosaic camera 6. If the 3D mosaic camera is located in row 3, section 8, seat 5 of football field bleachers, then the view V as seen by the user via HMD 34 will appear the same as if the user were sitting in row 3, section 8, seat 5 of the bleachers.

However, for the reasons described previously, it may be preferable to place the 3D mosaic camera further back from the field (e.g., nowhere near the front rows). In this case, as the distance from the 3D mosaic camera 6 to the field of interest 16 grows, the 3D experience due to the separation d between cameras 4 in camera pairs 8 becomes diminished. To assuage this problem, as shown in FIG. 6, the distance d_{c} between corresponding cameras 4a, 4a (i.e., cameras that are part of a 3D image camera pair 8) may be made substantially greater than distance dₕ, or the approximate or average distance between human eyes. Thus, because dₕ is known, then for any given choice of d_{c} and d_{co} (the distance from the 3D mosaic camera 6 to object of interest 12), dₕₒ can also be computed. The distance dₕₒ is the distance from the object of interest 12 to the eyes of a virtual observer 14. Notice that the location of virtual observer 14 is determined such that the rays of light that would pass through the eyes of virtual observer 14 in fact pass through the corresponding cameras 4a, 4a of a given camera pair 8. The eyes of the virtual observer 14 are, effectively, the eyes through which the user experiences view V of the object space containing the object of interest 12. For the 3D view V according to the embodiment shown in FIG. 6 to look realistic, the size of view V must also be adjusted to appear the same size as it would appear to virtual observer 14. Thus, this 3D mode may only be available in a preset or predetermined zoom level. If the 3D view is shown to the user without ensuring that the zoom level is also properly set, then the resulting view V may confuse the user's brain, because the object of interest 12 may appear too large or too small, given the user's experienced distance to the object of interest 12 (i.e., given the distance of the virtual observer 14 to the object of interest 12).

An interesting feature arises with the embodiment shown in FIG. 6. Unlike the example shown in FIG. 2 in which the distance d in 3D mosaic camera 6 is fixed at the distance between human eyes, and also in which the user experiences the same 3D perspective as if she were located precisely at the location of the 3D mosaic camera, the example shown in FIG. 6 provides an entirely different perspective to the user (who sees view V on HMD 34). Notice in FIG. 6 that, if the object of interest 12 moves upward, then even though mosaic cameras 2 (or one 3D mosaic camera 6) remain fixed, the location of the virtual observer 14 also moves upward. Thus, if the user has selected the 3D mode, as she moves her head around (thus providing selection instructions to the second image processor 26), not only is she able to see in the direction that she chooses, but it actually looks or feels as if her body is moving around with her viewpoint. For example, assume that the user is watching a football game with a system according to the present invention. In the 2D mode, which she selects with an input via interface 28, she can look up, down, left, and right in the mosaic M, thus giving her a view similar to that if she were sitting in the bleachers 18 at the game. Further, she can also zoom in and out as she pleases, as if she possessed a pair of binoculars. Then, she switches to a 3D mode. Suddenly, the left and right displays on her HMD 34 provide different images as described previously, thus providing a 3D perspective of the game. As discussed, the 3D mode may be associated with a preset zoom level (i.e., the size of view(s) V with respect to mosaic(s) M may be preset, because otherwise the user may perceive the object of interest 12 as being unusually small or large). In the 3D mode, it now appears to the user that she is “floating” over her chosen object of interest 12 by a certain distance, such as 20 feet. She starts watching one football player running with the football, and as her head moves, her view V may also change accordingly, and it visually appears to her also that her body is moving with the player. Thus, she appears to remain approximately 20 away from whatever she looks at, and keeps a 3D perspective of whatever she looks at. Then, she desires to change her zoom level (such as to zoom out), and she switches back to the 2D mode where she can adjust her zoom level. This embodiment may be suited well to an application in which the distance d_{co} does not change substantially for any given object of interest 12 in the object space, such as on a talk show.

In a preferred embodiment, there are at least 9 cameras 4, although there could be 100 such cameras 4 or more. Further, the present invention is preferably directed to streaming video that refreshes at a rate of 15 frames per second or more, preferably 30 frames per second or more. Of course, the selection instructions provided by the user via interface 28 also preferably have the same or close to the same rate.

Other embodiments or features will be described here. First, the view V as shown to the user via display 20, 34 may also include a window showing a “regular” view of the object space, such as that typically televised. For example, in the case of a football game of which a normal public broadcast is videographed, in a corner of the view V as shown to the user there may include a window which displays the normal public broadcast. Next, the method according to the present invention may be performed with only a portion of a full mosaic, to reduce the required bandwidth of the cable or information line 30. For example, if the view V that is being shown to the user via display 20, 34 comprises information from two adjacent images, where each image is transmitted over a different cable channel, then the second image processor 26 could selectively collect only images from those two channels (i.e., the second image processor 26 could receive only these images from the image distributor 24 over cable or information line 30) and create a smaller composite mosaic of those two images. Of course, the selected view V could then be extracted from that smaller mosaic. Whenever the user provides selection instructions to the second image processor 26 to select a view of a part of the full mosaic requiring different or additional images (or cable channels), then the second image processor 26 may simply notify the image distributor 24 and collect the needed images. Again, a new, smaller mosaic is formed from which the selected view V may be extracted. Further, if the bandwidth of the cable or information line is particularly limited, then a lower resolution of each of the required images may be requested and received by the second image processor 26. In the extreme version of this embodiment (where the second image processor 26 receives only the image information that it needs to provide selected view V to the user), the creation of the mosaic and the extraction of the selected view V effectively occurs before sending the view V over the cable or information line 30, so that the cable or information line 30 need only have sufficient bandwidth for the selected view (or the version of the selected view formatted for the display 20, 34).

Next in a more elaborate version of the present invention, it has been discussed that placing the mosaic camera 2 near the field of interest 16 (or object of interest 12) may result in adjacent cameras 4 having substantially different focal distances. Further, the field of view imaged by each camera 4 may include objects whose distances to the camera 4 vary widely. Thus, for any given focal distance (whether fixed or chosen automatically or manually), there may be many objects in the object section imaged by the camera 4 that are out of focus. The user may be interested in viewing such objects. To accommodate the user, there may be provided for each object section several cameras, each camera having a different focal distance, so that each object in the object section is in best focus with respect to one of the cameras 4. Thus, a plurality of mosaics may be created by the first image processor 22, corresponding to a plurality of focal distances. The interface 28 may include a retinal distance detector, such as a laser and reflector system, configured to measure a distance to the user's retina, or to measure a distance from the lens of the user's eye to the retina, or the like. Thus, based on this distance, the second image processor 26 may be able to determine at what focal distance the user's eye is attempting to focus. Based on this information, the correct mosaic may be chosen and the selected view V selected from that mosaic. To further illustrate, assume that in a given image there is imaged a football in the foreground and a football player in the background. Assume further that such an object section is imaged by two cameras, one focused on the foreground of that object section and the other focused on the background of that object section. The user attempts to look at the player in the background. In doing so, his eyes adjust and a distance between his eye lens and retina changes accordingly. The retinal distance detector measures this change, and chooses the mosaic corresponding to the backgrounds of the imaged object sections. The selected view V is then extracted from that background mosaic and displayed to the user via the display 20, 34. Of course, each object section in the object space may be imaged by a plurality of cameras 4, each camera 4 focused on different planes in that object space (i.e., each camera 4 having a different focal distance). The 3D version of the present invention may also be combined with this feature, thus providing to the user a 3D perspective of an object space, where the view can be changed by the user moving his head, and where he can focus on virtually any object in the entire object space.

The present invention is not limited to the embodiments or examples given.

1. A method for producing a selectable view of an object space, comprising:
a) dividing said object space into a plurality n of object sections to be imaged;
b) providing at least n cameras, wherein said cameras are configured such that each object section is associated with at least one unique camera configured to image substantially only said object section; and
c) imaging each of said object sections with said unique camera unique to said each of said object sections, so as to create at least one image of each object section,
wherein said images of said object sections are combined to create a substantially continuous composite mosaic of said object space,
wherein a view of a portion of said mosaic is selectably provided to a user based on selection instructions from said user, and
wherein at least one of said view, said mosaic, and said images of said object sections is sent to said user via an information network.

2. A method as in claim 1, wherein said view is provided to said viewer via a head-mounted display.

3. A method as in claim 2, wherein said view is selectable by said user based at least in part on a physical orientation of said head-mounted display.

4. A method as in claim 1, wherein at least two of said object sections are imaged at different focal distances.

5. A method as in claim 1, wherein said information network is a cable television network.

6. (Canceled)

7. A method as in claim 5, wherein n is at least 9.

8. (Canceled)

9. A method as in claim 7, where step c) comprises imaging each of said object sections with a refresh rate of at least 15 times per second, wherein said view is selectably provided to said user with a refresh rate of at least 15 times per second.

10. A method as in claim 9, wherein said object space comprises a field for a sporting event.

11. A method as in claim 10, wherein said view is provided to said viewer via a head-mounted display, wherein said view is selectable by said user based at least in part on a physical orientation of said head-mounted display.

12. (Canceled)

13. A method as in claim 1, wherein step b) comprises providing 2n cameras, wherein said cameras are configured such that each object section is associated with two unique cameras, spaced an approximate distance d apart, configured to image substantially only said object section,
wherein step c) comprises imaging each of said object sections with said two unique cameras, so as to create first and second images of each object section,
wherein said first images of said object sections are combined to create a first composite mosaic of said object space, and said second images of said object sections are combined to create a second composite mosaic of said object space,
wherein a view of a portion of said first mosaic and a corresponding view of a corresponding portion of said second mosaic are selectably provided to said user based on selection instructions from said user, so as to provide to said user a three-dimensional representational view of a portion of said object space, and
wherein at least one of the following are sent to said user via said information network: 1) said view and said corresponding view; 2) said first and second images of said object sections; and 3) said first and second mosaics.

14. A method as in claim 13, wherein said distance d is an approximate distance between human eyes.

15. A method as in claim 13, wherein said distance d is substantially greater than an approximate distance between human eyes.

16. A system for providing a selectable view of an object space, comprising:
a plurality of cameras configured to image a plurality of object sections of said object space, wherein each object section is associated with at least one unique camera configured to image substantially only said object section;
a first image processor connected to said plurality of cameras and configured to combine said images of said object sections into a substantially continuous composite mosaic of said object space;
a second image processor connected to said first image processor and configured to extract a selected view of a portion of said mosaic from said mosaic based on selection instructions from a user;
a display connected to said second image processor and configured to display said selected view to said user; and
an interface connected to said second image processor and configured to provide said selection instructions to said second image processor.

17. A system as in claim 16, wherein said display is a head-mounted display.

18. A system as in claim 17, wherein said interface comprises an orientation detector configured to detect a physical orientation of said head-mounted display, wherein said selection instructions are based at least in part on said physical orientation.

19. (Canceled)

20. A system as in claim 16, wherein said selection instructions comprise at least two components: a) a position component corresponding to a position of said selected view with respect to said mosaic; and b) a size component corresponding to a size of said selected view with respect to said mosaic, wherein said user may zoom-in in said mosaic by decreasing the size of said selected view and may zoom-out in said mosaic by increasing the size of said selected view.

21. A system as in claim 16, wherein each object section is associated with two unique cameras, spaced an approximate distance d apart, configured to image substantially only said object section, so as to create first and second images of said object section,
wherein said first image processor is configured to combine said first images of said object sections into a first composite mosaic of said object space, and to combine said second images of said object sections into a second composite mosaic of said object space,
wherein said second image processor is configured to extract a selected view of a portion of said first mosaic and a corresponding view of a corresponding portion of said second mosaic based on selection instructions from said user, and
wherein said display comprises a first-eye display and a second-eye display and is configured to display said selected view to said user via said first-eye display and to display said corresponding view to said user via said second-eye display.

22. A system as in claim 21, wherein said selection instructions comprise a 3D/2D component corresponding to a selection between a three-dimensional and a two-dimensional view, respectively.

23. A system as in claim 16, wherein each object section is associated with at least two unique cameras configured to image substantially only said object section, wherein said at least two unique cameras have different focal distances, wherein said selection instructions comprise a focus component corresponding to a selection between images created by said at least two unique cameras.

24. A method for producing a selectable view of an object space, said object space video-imaged so as to create a first series of images of said object space, comprising:
a) receiving an image of said first series of images from a remote source via an information network;
b) receiving selection instructions from a user;
c) selecting a portion of said image based at least in part on said selection instructions;
d) providing said portion to a first display viewable by said user and configured to display said portion; and
e) repeating steps a), c), and d) at a first rate and step b) at a second rate so that said portions displayed by said first display appear as a first continuous video, and so that subsequent portions displayed by said first display correspond to selected portions of subsequent images of said first series.

25. The method as in claim 24, wherein said display is a head-mounted display, wherein said selection instructions are based at least in part on a physical orientation of said head-mounted display.

26. The method as in claim 24, wherein said selection instructions comprise at least two components: a) a position component corresponding to a position of said portion with respect to said image; and b) a size component corresponding to a size of said portion with respect to said image, wherein said user may zoom-in in said image by decreasing the size of said portion and may zoom-out in said image by increasing the size of said portion.

27. The method as in claim 24, wherein said object space is three-dimensionally video-imaged by at least a first and a second camera, spaced a distance d apart, configured to create at least a first and a second series of images, respectively, of said object space, further comprising:
f) receiving an image of said second series of images from said remote source;
g) selecting a portion of said image of said second series based at least in part on said selection instructions;
h) providing said portion of said image of said second series to a second display viewable by said user and configured to display said portion of said image of said second series; and
i) repeating steps f)-h) so that said portions displayed by said second display appear as a second continuous video and so that subsequent portions displayed by said second display correspond to selected portions of subsequent images of said second series,
wherein said first and second displays are configured so that said first and second continuous videos appear as a three-dimensional continuous video.
